(19) United States
(12) Patent Application Publication
(10) Pub. No.: US 2004/0143651 A1
(43) Pub. Date: Jul. 22, 2004

(54) System and method for distributing configuration changes made to a printing device

(76) Inventors: Kram H. Allen, Meridian, ID (US); Linn J. Kropf, Boise, ID (US); Brett Green, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/349,264

(22) Filed: Jan. 21, 2003

(51) Int. Cl. G06F 15/177

(52) U.S. Cl. 709/221; 709/203

(57) ABSTRACT

A method is provided for distributing configuration changes made to a printing device in communication with a printer web server. The method includes the step of receiving a configuration change made to the printing device, in the printer web server. Another step is arranging a connection between the printer web server and a client web server located on a client device using an electronic communications protocol. A formatted message can be sent from the printer web server to the client web server, and the formatted message alerts the client web server to the configuration change made to the printing device. A further step is updating configuration data for the printing device stored on the client device.

### FIELD OF THE INVENTION

The present invention relates generally to distributing configuration changes made to a printing device.

### BACKGROUND

When computer printing devices were first used in personal computing environments, the printing devices received character-based information and printed the character-based information using associated control codes. Such printing devices included a rudimentary amount of logic and the inline control codes were included with the actual data to be printed.

As computer printing devices have become more powerful, additional logic and processing power have been incorporated into the printing device or printer. Computer printing devices are now able to store a large number of printer settings and process complex printer languages for controlling printing, such as PostScript, or PCL (Printer Control Language). Printer languages enable a printing device to print more complex documents and graphic-oriented files.

A more recent addition to computer printing devices is the inclusion of an embedded web server into the printing device. Computer printers have also begun to be combined with copiers, facsimiles, and imaging machines. Accordingly, web servers have also been associated with such copying, printing, and imaging services. Web servers provide a uniform interface through which a user of a printing device is able to connect to the printing device and view the status of the printing device's properties and attributes, or make changes to the printing device's status. Printing device status and changes can be viewed through a graphical user interface or web browser.

For example, if a user changes a setting on a specific printing device, then the associated embedded web server (EWS) will reflect this change. However, if a second user changes the same setting (or another setting for that printer), the first user will be unaware of this change. The reason the first user will be unaware of the change is because the first user may still have an old copy of the web page from the printer web server cached in the user's web browser.

In order to receive an updated version of the configuration or properties data, the first user needs to know when to refresh their EWS web page. In other words, the user needs to refresh their web browser every time the user desires to determine the printing device's status. This generally makes a user poll the printing device to maintain a current status of the printing device. Polling can be a nuisance to an end user and remembering to constantly refresh a web page to determine the printing device or printer status is not a workable solution for users. The need for polling or refreshing the data can lead to frustration on the part of users, who expect to be able to view the current printer status when they view the printer status web page in their web browser.

In addition, users expect to set a printing device or printer to a specific setting and have the printing device remain at that setting while they are printing. If a user sets a printing device to a specific setting and another user has changed that setting in the meantime, then the printing device will print that document with the changed setting. This problem can also be frustrating to users. Especially in the case where there are tens or even hundreds of users connected to a specific printing device.

In order to overcome this problem in the past, printing communication configurations have been created that allow a user's client computer to automatically poll a web server associated with the printing device at frequent intervals. Using polling, the user is made aware of changes that are made to the printing device. One method used in automatic polling is to provide a trap or variable that is located on the printing device. When a printer setting is modified, then the trap can be set. Even though the trap has been set after a configuration change, the client computer still has to poll to find out when the trap has changed. Using a trap reduces the burden on the printing device because the printing device does not have to respond synchronously to polling. However, a trap does not eliminate the polling that is required by the user's machine to request the information stored in the trap.

One drawback of polling is that it consumes a measurable amount of the user's computing resources. These resources may be put to better use by the client computer in other applications, as opposed to being used in the repeated polling of the printing device. Unfortunately, prior systems for monitoring printer configurations have not provided a way to avoid time consuming and compute intensive polling.

Another drawback of polling methods is the use of proprietary communication software and protocols. Custom software must be programmed and configured to make this type of communication system possible. The printer vendor may provide this custom software to communicate with the printer. In addition, a network administrator is needed to install and configure the proprietary software on each client machine for the automated polling or manual polling of the printer. The use of proprietary communication software and protocols creates a significant amount of overhead for a printer vendor in the creation and distribution of such proprietary software.

### SUMMARY OF THE INVENTION

The invention provides a method for distributing configuration changes made to a printing device in communication with a printer web server. The method includes the step of receiving a configuration change made to the printing device in the printer web server. Another step is arranging a connection between the printer web server and a client web server located on a client device using an electronic communications protocol. A formatted message can be sent from the printer web server to the client web server, and the formatted message alerts the client web server to the configuration change made to the printing device. A further step is updating configuration data for the printing device stored on the client device.

### BRIEF DESCRIPTION OF THE DRAWINGS

FIG. 1 is a block diagram illustrating a system for distributing configuration changes made to a printing device with a web server in accordance with an embodiment of the present invention;

FIG. 2 is a block diagram illustrating an embodiment of a system for distributing configuration changes where the web server is associated with the printing device;

FIG. 3 is a flow chart illustrating an embodiment of a method for distributing configuration changes from a printing device to a client device; and

FIG. 4 is a flow chart illustrating an embodiment of a method for distributing configuration changes from a printing device to a client device using hypertext transfer protocol (HTTP).

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention includes a system and method to distribute configuration changes made in a networked printing system. This invention helps solve the problems associated with printer settings changing in a printing device when multiple users are connected to the printing device. The problem where end users are not aware that printer configuration changes are being made to a printing device can be avoided using this invention.

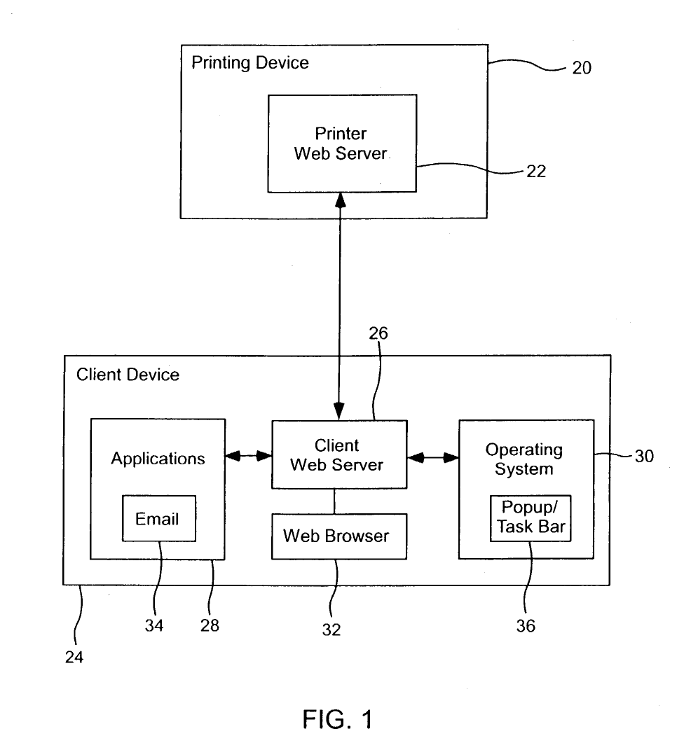

FIG. 1 illustrates that the system includes a printing device 20 or printer having a print configuration. The print configuration can include specific print settings or properties such as paper tray selection, print quality, number of pages per sheet, color management options, and similar print configurations. The printing device is enabled to print information received across a network. For example, the printing device can receive word processing documents, spreadsheets, graphic information, or other information to be printed.

A printer web server 22 is in communication with the printing device or printer 20. The printer web server may be embedded into the printer electronics or just physically located within the printer housing as a separate electronic entity. The printer web server is configured to store the print configuration and communicate information about the print configuration of the printing device via an electronic communications protocol such as TCP/IP, IPX/SPX, or hypertext transfer protocol (HTTP). This print configuration information can be sent using a specific protocol to any device on the network that can process the same protocol and present the information to an end user.

A client device 24 is in networked communication with the printing device 20 and the printer web server 22. An example of a client device may be a computer workstation or personal computer that is using the printing device to print documents and information. Located within the client device is a client web server 26. The client web server is configured to receive one or more network communication messages from the printer web server when changes are made to the print configuration. These network messages can be communicated by or encapsulated within TCP/IP, hypertext transfer protocol (HTTP) or other well known communication protocols. Once the client web server has received the communication from the printer web server, the client web server can notify a user of changes to the print configuration.

A web browser 32 can be included and enabled to be activated by the client web server 26 to notify the user of a change made to the print configuration. When the client web server receives notice of a change to the print configuration, it can open the web browser and send the changed information to the web browser. The web browser can then display this information to the end user. Alternatively, the web browser may already be open on the user's operating system desktop and the system can refresh the client web browser to notify the user of changes to the print configuration. The client web server can also cache or store the changed information until the user is ready to view the information.

Alternative ways that the client web server 26 can notify an end user of changes to the print configuration are through applications 28 such as email 34. The client web server can communicate with other applications that are configured or customized to accept HTTP and/or other well known protocols such as TCP/IP. In addition, the client web server can communicate with the operating system 30 and activate a popup window or a taskbar notification 36. Thus, the client web server can send information through well known protocols to applications or the operating system.

One useful aspect of this embodiment is that the client device 24 does not synchronously poll the printer web server 22 to determine if a configuration change has been made. The client web server 26 can register with the printer web server each time the client device or client web server is started. Anytime a change is made, the printer web server can initiate or arrange a connection with the client web server. Since the printer web server initiates this communication when changes are made, the total amount of communication between the two servers is reduced as compared to polling.

Using a web browser or a familiar application to notify a user that a change has been made is also valuable because it allows a user to view printing configuration changes in a familiar environment and navigate through the information easily. For example, if a user views print configurations through the web browser, the user is more likely to understand the information more quickly. In contrast, a proprietary software tool may be less familiar to the user. Specifically, some proprietary tools for controlling and viewing print configurations are difficult to use. Further, a nonstandard interface may be used in proprietary software and this requires users to master yet another application interface.

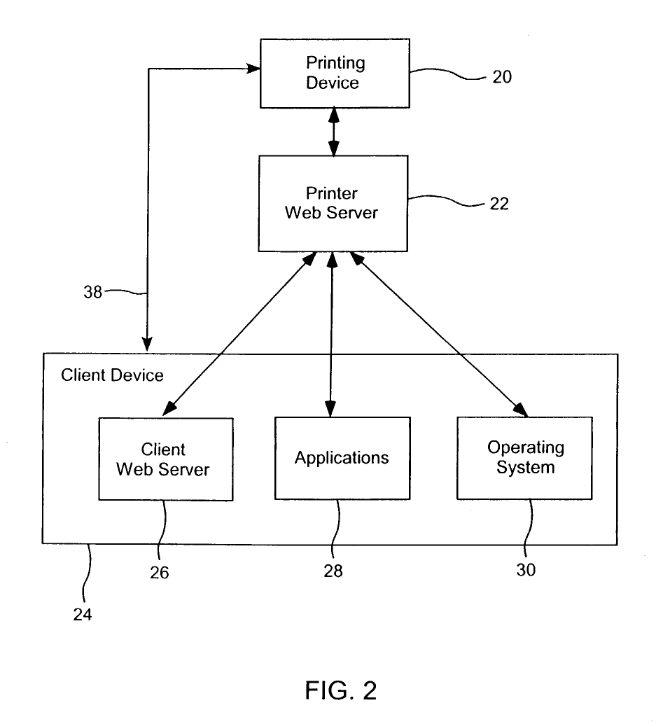

FIG. 2 illustrates another embodiment of a system to distribute configuration changes made in a network printing system. Specifically, the printer web server 22 is not located within the printer 20, but the printer web server is coupled via a cable, network connection, or wireless connection to the printer. In addition, the client device 24 is illustrated as independently communicating with the printing device 38 but the client device may also communicate to the printing device through the printer web server. The client device has a number of components that can communicate with the printer web server. Specifically, the client web server 26, applications 28, and operating system 30 can be in communication with the printer web server and receive information about print configurations or configuration changes from the printer web server.

Arranging the components as illustrated in FIGS. 1 and 2 provides a system that is more useful and flexible than prior systems for controlling printing devices on a network. Users who are connected to the printing device are able to view the status of and change settings on a printer through a web browser or any of the mechanisms described. Using a client web server to inform users when changes are made to the printer is convenient for users because the users can be actively notified. Selecting a desired notification method for the user is also valuable because each user can customize the notifications they receive according to a preferred style of communication (i.e. email, instant messaging, etc.).

Another valuable aspect of the present invention is that the communication components between the printer web server and client web server can use a number of commonly used industry tool sets. For example, the communication between the printer web server and the client web server can use HTTP and/or TCP/IP. HTTP and TCP/IP enabled software is bundled with the operating system on many work stations and personal computers. Thus, this communication channel is easier to setup, debug, and test.

Web servers are well known computer industry components and many versions of inexpensive or freeware web servers are available. Some operating system configurations even come with a web server installation that is complete and can be activated. Using widely available communication protocols and server components makes it easier and faster to deploy an active notification mechanism for the printing management system.

The present system provides peer-to-peer communication between the printer web server and client devices that are located on the network. As a result, client devices are not required to poll to find out the status of a printing device, but the client devices can wait for a communication directed to them. This asynchronous communication frees up computing resources on a client device and the printing device while preserving the opportunity of knowing whether changes are taking place on a printing device.

An additional embodiment of the invention can use simple network management protocol (SNMP) to inform a user about the state of printer hardware. Because SNMP is a protocol that facilitates the exchange of management information between network devices, the SNMP status information can be mapped to the HTTP communication (or another standard communication protocol) by the client web server. This information regarding the status of the network printer can then be transmitted to the client device. SNMP typically focuses on hardware status but it can also be extended to cover the software oriented configuration elements in a printing device.

In the present discussion when the term printer or printer device is used, this may refer to many types of printing systems. For example, the term printing device can refer to a laser printer, dot matrix printer, combination copier and printer, plotter, heat transfer printer, offset press, or any other network device that can print hard copy output for a user. Any discussion of connecting devices together in this description may refer to a network connection but it may also include a wireless connection, infrared connection, etc.

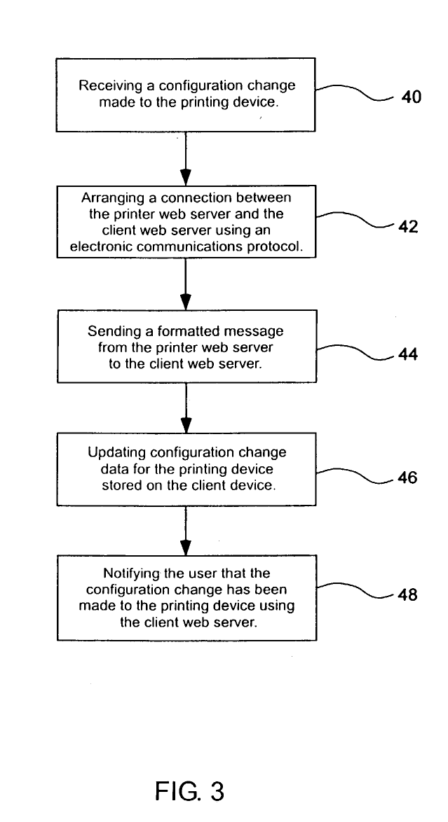

FIG. 3 illustrates a method for distributing configuration changes made to a printing device in communication with a printer web server. The method includes the step of receiving a configuration change made to the printing device in the printer web server in block 40. When the configuration change is received from the printing device it can also be stored for some length of time in the printer web server. Then a connection is arranged between the printer web server and a client web server located on the client device using an electronic communications protocol in block 42. The electronic communications protocol used can be any well known networking protocol used in computer networking.

Another step is sending a formatted message from the printer web server to the client web server in block 44. The formatted message alerts the client web server to the configuration change made to the printing device. The printer web server is an active element of this step because it can quickly communicate the configuration changes to the client web server after the changes have taken place. The formatted message can include information about the configuration change(s) made to the printing device and other relevant information. A print configuration change may include changes to the properties for a paper tray source, a page layout, watermarking, account identification information, image resolution quality, font configuration, watermarks included in the document, and even login information for the specific printing device. In addition, folding, binding, and finishing options can be included if the printing device includes hardware for folding and binding printed material.

An additional step is updating configuration data for the printing device stored on the client device in block 46. This updated information can be written to a local web browser cache or another local storage location for retrieval. Storing the data locally allows the user to access the stored configuration data when viewing the information for the printing device. When the user opens an application or web browser to inquire about status of a printing device, this stored information can be retrieved from the local storage without requesting this information from the printer web server.

Once the data has been received by the client device, the user can be notified using the client web server that the configuration change has been made to the printing device in block 48. Enabling the system to automatically notify a user of changes avoids surprises for the user when changes are made to a printer. Otherwise, a user may not know if changes have been made to a printer and the user can inadvertently print to a printer after changes have been made by a third party.

As discussed, the notification can take place using a web browser, email or similar notification methods. For example, the client web server can send an email to the user to notify the user that a configuration change has been made to the printing device. Other applications, such as instant messaging or similar communication channels, can be used to notify the user.

Operating system user interfaces can be used by the client web server to notify a user that a configuration change has been made to the printing device. An example of an operating system function is the presentation of a popup window that is activated by the client web server. The popup window may include the change made to the printing device and any other relevant printing configuration information. Other notification elements can be used in the operating system such as the taskbar notification. The client web server can send the configuration change information to the operating system which passes the change information on to the taskbar notification. Accordingly, a notification can appear on the taskbar to alert the user to the fact that a configuration change has been made to the printing device.

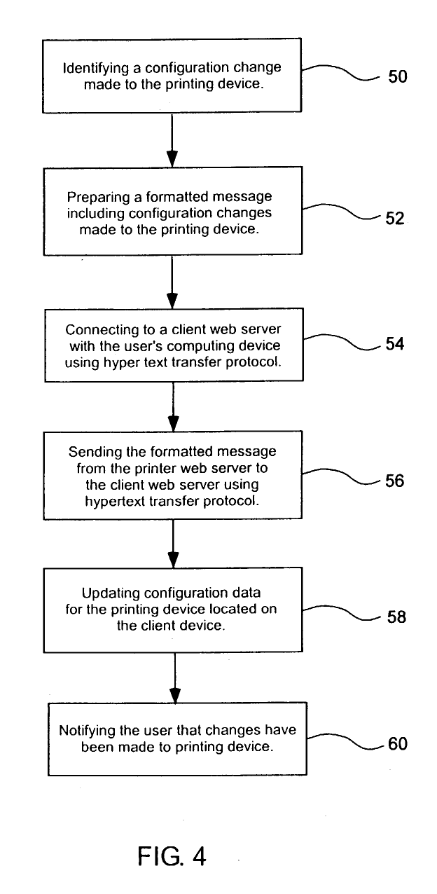

FIG. 4 illustrates a more detailed method for distributing configuration changes made to a printing device where the printing device has a printer web server. The method includes the step of identifying a configuration change made to the printing device in block 50. As an example, the printing device or printer can notify the printer web server that a change has been made and the printer web server can store the change on its local storage.

Next, a formatted message can be prepared in the printer web server which includes a configuration change made to the printing device in block 52. An example of implementing the formatted message is using a POST method sent through HTTP. The POST method allows the printer web server to provide a block of data to a data handling process on the client web server. The data handling process can be a form that is presented on the client web server. Alternatively, the POST method may extend the database through an append operation. The actual format of the POST method is determined by the data format that the client web server has been configured to accept. In another embodiment, the client web server can host an executing process that expects data from the POST method in a predefined format. Another example of a preformatted message can be a TCP/IP packet which contains data in a predefined format that can be received and processed by the client web server.

After a formatted message has been prepared, the printer web server connects to a client web server located on the client device using hypertext transfer protocol (HTTP) in block 54. Since the client web server may be listening on a pre-selected server port, the client web server can receive information about printer configuration changes at anytime in an asynchronous manner. Receiving the information asynchronously reduces the processing load on the client device and the communication between the web servers does not consume resources when the communication link is inactive. This is in contrast to previous methods where the client device was constantly polling printers to determine their status.

Once the connection between the two servers has been made, the formatted message can be sent from the printer web server to the client web server using HTTP in block 56. The formatted message alerts the client web server to the configuration change made to the printing device.

The information received in the formatted message can then be used to update configuration data for the printing device located on the client device in block 58. A client device can store this configuration in its local storage, such as a hard drive, a Flash RAM, or in a local storage space allocated with the client web server. This allows a user to retrieve this locally stored information when the printer configuration is displayed in a local web browser or a similar application.

In addition to merely storing the configuration data received for later viewing, the system can also actively notify the user that changes have been made to the printing device in block 60. As discussed previously, this notification can take place through a number of information channels, such as emailing the user, refreshing the web browser, opening a popup window, activating a taskbar notification, or using similar methods.

The present invention can also help avoid applying strict security controls to printers and their printer web servers. When such security is used it limits the changes that can be made by specific users. For example, the system administrator can prohibit all non-administrators from making changes to the printer configuration. This type of security is used where individuals are making changes to the printer and the changes interfere with other users. The present invention avoids this problem because every user can be notified about the current printing device settings and this avoids the use of strong security mechanisms on the printer web server.

In summary, the present invention helps solve the problems created when multiple users can make independent changes to a printer device's configuration or properties. When multiple users are allowed to make changes to the printer settings, this creates confusion because the printer settings will be changed by a single user and then other users will print after the configuration changes have been made. This means the modified configuration changes are likely to be incorrect for the other users. Using the system and method described above enables every user on the network to receive printing device configuration information in a timely fashion. In addition, users can also determine that they want to be actively notified that changes have been made. This way users can modify a recent configuration change or find the individual who is making the problematic changes.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for distributing configuration changes made to a printing device in communication with a printer web server, comprising the steps of:
receiving a configuration change made to the printing device in the printer web server;
arranging a connection between the printer web server and a client web server located on a client device using an electronic communications protocol;
sending a formatted message from the printer web server to the client web server, and the formatted message alerts the client web server to the configuration change made to the printing device; and
updating configuration data for the printing device stored on the client device.

2. A method as in claim 1, notifying a user using the client web server on the client device that the configuration change has been made to the printing device.

3. A method as in claim 2, wherein the step of notifying a user further comprises the step of notifying the user that the configuration change has been made to the printing device, using a hypertext transfer protocol (HTTP) message sent to the user's web browser.

4. A method as in claim 2, wherein the step of notifying a user further comprises the step of sending the formatted message to the client web server using hypertext transfer protocol (HTTP).

5. A method as in claim 2, wherein the step of notifying a user further comprises the step of sending the formatted message to the client web server using a hypertext transfer protocol (HTTP) POST method.

6. A method as in claim 5, further comprising the step of receiving the hypertext transfer protocol (HTTP) POST method using a form on the client web server.

7. A method as in claim 2, further comprising the step of enabling the client web server to register with the printer web server in order to receive a hypertext transfer protocol (HTTP) message including configuration changes made to the printing device.

8. A method as in claim 2, wherein the step of notifying a user further comprises the step of activating a web browser using the client web server on the client device to notify the user the configuration change has been made to the printing device.

9. A method as in claim 2, wherein the step of notifying a user further comprises the step of refreshing a web browser via a request from the client web server to notify the user the configuration change has been made to the printing device.

10. A method as in claim 2, wherein the step of notifying a user further comprises the step of presenting a popup window activated by the client web server on the-client device to notify the user the configuration change has been made to the printing device.

11. A method as in claim 2, wherein the step of notifying a user further comprises the step of notifying the user via email initiated by the client web server to notify the user the configuration change has been made to the printing device.

12. A method as in claim 2, wherein the step of notifying a user further comprises the step of activating a task bar notification from the client web server to notify the user that the configuration change has been made to the printing device.

13. A method for distributing configuration changes made to a printing device in communication with a printer web server, to a client device, comprising the steps of:
identifying a configuration change made to the printing device;
preparing a formatted message in the printer web server to communicate a configuration change made to the printing device;
connecting the printer web server to a client web server located on the client device using hypertext transfer protocol (HTTP);
sending the formatted message from the printer web server for the printing device to the client web server for the client device using hypertext transfer protocol (HTTP) and the formatted message alerts the client web server to the configuration change made to the printing device; and
updating configuration data for the printing device located on the client device.

14. A method as in claim 13, further comprising the step of notifying a user of the configuration change made to the printing device.

15. A method as in claim 13, further comprising the step of enabling the client web server to register with the printer web server in order to receive a hypertext transfer protocol (HTTP) message about the configuration change.

16. A method as in claim 14, wherein the step of notifying the user further comprises the step of sending the formatted message to the client web server using a hypertext transfer protocol (HTTP) POST method.

17. A method as in claim 16, further comprising the step of receiving the hypertext transfer protocol (HTTP) POST method using a form on the client web server.

18. A method as in claim 14, wherein the step of notifying the user further comprises the step of activating a web browser on the client device using the client web server in order to notify the user the configuration change has been made to the printing device.

19. A method as in claim 14, wherein the step of notifying a user further comprises the step of refreshing a web browser via a request from the client web server to display the configuration change made to the printing device.

20. A method as in claim 14, wherein the step of notifying a user further comprises the step of presenting a popup window on the client device as activated by the client web server to notify the user the configuration change has been made to the printing device.

21. A method as in claim 14, wherein the step of notifying a user further comprises the step of notifying the user via an email initiated by the client web server that the configuration change has been made to the printing device.

22. A method as in claim 14, wherein the step of notifying a user further comprises the step of activating a task bar notification from the client web server to notify the user the configuration change has been made to the printing device.

23. A system to distribute configuration changes made in a network printing system, comprising:
a printing device having a print configuration, and enabled to print information received across a network;
a printer web server in communication with the printing device, configured to record and communicate information about the print configuration of the printing device;
a client device in communication with the printer web server; and
a client web server located in the client device and configured to receive a formatted message from the printer web server when changes are made to the print configuration, and configured to notify a user of changes to the print configuration.

24. A system as in claim 23, further comprising a web browser enabled to be activated by the client web server to notify the user of a change made to the print configuration.

25. A system as in claim 24, wherein the web browser is refreshed by the client web server to notify the user of changes to the print configuration.

26. A system as in claim 23, further comprising a popup window which can be activated by the client web server to notify the user of a change to the print configuration.

27. A system as in claim 23, further comprising an email notification sent by the client web server to notify the user of a change made to the print configuration.

28. A system as in claim 23, further comprising a task bar notification activated by the client web server to notify the user of a change to the print configuration.

29. A system as in claim 23, wherein the formatted message is sent via hypertext transfer protocol (HTTP).

30. A system to distribute configuration changes made in a network printing system, comprising:
a printing means having a print configuration, for printing information received across a network;
a printer web server means in communication with the printing means, for recording and communicating information about the print configuration of the printing device via hypertext transfer protocol (HTTP);
a client device in networked communication with the printer web server; and
a client web server means located in the client device for receiving a hypertext transfer protocol (HTTP) message from the printer web server when changes are made to the print configuration and for notifying a user of changes to the print configuration.

31. A system as in claim 30, further comprising a web browser means enabled to be activated by the client web server and for notifying the user of a change made to the print configuration.

32. An article of manufacture, comprising:
a computer usable medium having computer readable program code embodied therein for distributing configuration changes made to a printing device in communication with a printer web server, the computer readable program code means in the article of manufacture comprising:
computer readable program code for receiving a configuration change made to the printing device in the printer web server;
computer readable program code for arranging a connection between the printer web server and a client web server located on a client device using an electronic communications protocol;
computer readable program code for sending a formatted message from the printer web server to the client web server, and the formatted message alerts the client web server to the configuration change made to the printing device;
computer readable program code for updating configuration data for the printing device stored on the client device; and
computer readable program code for notifying a user using the client web server on the client device that the configuration change has been made to the printing device.
